(19) United States
(12) Patent Application Publication
(10) Pub. No.: US 2025/0097391 A1
(43) Pub. Date: Mar. 20, 2025

(54) METHOD AND APPARATUS FOR PROJECTOR CAMERA COMMUNICATION

(71) Applicant: TEXAS INSTRUMENTS INCORPORATED, Dallas, TX (US)

(72) Inventors: Jaime De La Cruz, Carrollton, TX (US); Jeffrey Kempf, Dallas, TX (US); Shivam Srivastava, Bangalore (IN)

(73) Assignee: TEXAS INSTRUMENTS INCORPORATED, Dallas, TX (US)

(21) Appl. No.: 18/470,649

(22) Filed: Sep. 20, 2023

(51) Int. Cl. H04N 9/31; G06T 7/90; H04N 23/61

(52) U.S. Cl. CPC H04N 9/3194; G06T 7/90; H04N 9/3147; H04N 23/61; G06T 2207/10024; G06T 2207/30242

(57) ABSTRACT

A system including at least one processor configured to determine a command pattern and a projector coupled to the at least one processor. The projector is configured to project an opening pattern, project the command pattern after projecting the opening pattern, and project a closing pattern after projecting the command pattern.

### TECHNICAL FIELD

The present application relates in general to projectors, and, in particular, to a method and apparatus for projector camera communication.

### BACKGROUND

In many projection applications, multiple projectors interact with each other. For example, multiple projectors may project portions of the same image to produce a larger image. It is desirable to have an automated, low cost method with minimal user interaction for projectors to communicate with each other. Some camera-projector systems include a permanently integrated camera, to form a camera-camera-projector system.

### SUMMARY

An embodiment includes a system including at least one processor configured to determine a command pattern and a projector coupled to the at least one processor. The projector is configured to project an opening pattern, project the command pattern after projecting the opening pattern, and project a closing pattern after projecting the command pattern.

An embodiment includes a system including a camera configured to capture a first image and at least one processor coupled to the camera. The at least one processor is configured to in response to determining that the first image is an opening pattern, instruct the camera to capture a second image, where the camera is configured to capture the second image. The at least one processor is also configured to, in response to determining that the second image is a command pattern, instruct the camera to capture a third image, where the camera is configured to capture the third image and in response to determining that the third image is a closing pattern, detect a command sequence.

An embodiment method includes obtaining, by at least one processor, an image and counting, by the at least one processor, a number of blobs in the image and a number of holes per blob. The method also includes determining, by the at least one processor, a hole count confidence level for the number of holes per blob the image and in response to determining that the hole count confidence level is greater than a threshold, identify a command based on the number of holes per blob.

### BRIEF DESCRIPTION OF THE DRAWINGS

For a more complete understanding of the illustrative examples of aspects of the present application that are described herein and the advantages thereof, reference is now made to the following descriptions taken in conjunction with the accompanying drawings, in which:

FIG. 1 illustrates an example camera-projector system;

FIGS. 2A-2M illustrate example projection patterns;

FIG. 3 illustrates example pattern broadcast and listening sequences;

FIG. 4 illustrates a flowchart of an example method of projector communication;

FIG. 5 illustrates a flowchart of another example method of projector camera communication;

FIG. 6 illustrates a flowchart of an example method of pattern cycle detection;

FIG. 7 illustrates a flowchart of an example method of projection pattern detection; and

FIG. 8 illustrates a flowchart for an example method of structured light characterization.

Corresponding numerals and symbols in the different figures generally refer to corresponding parts unless otherwise indicated. The figures are drawn to clearly illustrate the relevant aspects of the illustrative example arrangements and are not necessarily drawn to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

In this description, elements that are optically coupled have an optical connection between the elements, but various intervening optical components can exist between elements that are optically coupled.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

Although the example illustrative arrangements have been described in detail, it should be understood that various changes, substitutions and alterations can be made herein without departing from the spirit and scope of the present application as defined by the appended claims.

In an example, a first camera-projector system containing a first projector and a first camera communicates with a second camera-projector system containing a second projector and a second camera. The first projector projects a first image on a projection surface. The second camera captures an image of the first projected image. The second camera-projector system decodes the captured image, and the second projector projects a second image on the projection surface based on the decoded captured image. Then, the first camera captures an image of the second projected image. A clock signal is not required for communication between the first camera-projector system and the second camera-projector system. In an example, the first camera-projector system projects an opening pattern, projects a command pattern after projecting the opening pattern, and projects a closing pattern after projecting the command pattern. The second camera-projector system decodes a command pattern sequence based on capturing an image of the opening pattern, capturing an image of the command pattern after capturing the image of the opening pattern, and capturing an image of the closing pattern after capturing the command pattern. In an example, the second camera-projector system performs error checking on the command pattern sequence. An example projector communication system is computationally inexpensive and has high robustness to projection surface geometry and other affine transformations. In an example, the opening pattern is a black field, the command pattern contains white blobs having black holes, and the closing pattern is a black field. In an example, the second camera-projector system responds by either projecting a green field to indicate successful communication or a red field to indicate a failed communication. An example uses a statistical voting scheme for pattern identification of the command pattern. An embodiment uses a camera which is embedded in the camera-projector system for other purposes.

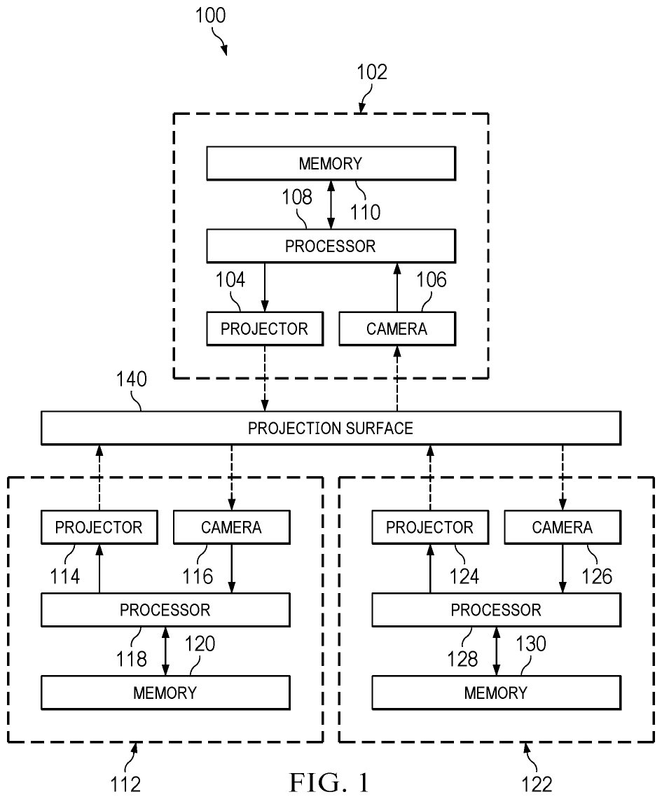

FIG. 1 illustrates an example projection communication system 100. The projection communication system 100 contains a camera-projector system 102, a camera-projector system 112, and a camera-projector system 122 optically coupled to a projection surface 140. The projection surface 140 may be one projection surface or multiple projection surfaces, for example a screen, a wall, a waveguide, a window, a road, or another projection surface. The projection communication system 100 contains three camera-projector systems, but different embodiments may have a different number of camera-projector systems, for example two camera-projector systems, four camera-projector systems, five camera-projector systems, six camera-projector systems, or more camera-projector systems, for example eight camera-projector systems. The camera-projector system 102 contains a processor 108 coupled to a projector 104, to memory 110, and to a camera 106. The processor 108, the projector 104, the memory 110, and the camera 106 are mechanically coupled to each other. The processor 108 determines an image for projection and the projector 104 projects the determined image to at least a portion of the projection surface. The processor 108 may be one processor or more than one processor. In an example the projector 104 projects a sequence of three images, an opening pattern, a command pattern after the opening pattern, and a closing pattern after the command pattern. The use of a command sequence with three patterns assists in the communication between the camera-projector system 102 and the camera-projector systems 112 and 122 without the use of a clock. The memory 110 stores patterns or indications of patterns for projection by the projector 104, for example the opening pattern, the command pattern, and the closing pattern, and patterns received by the camera 106.

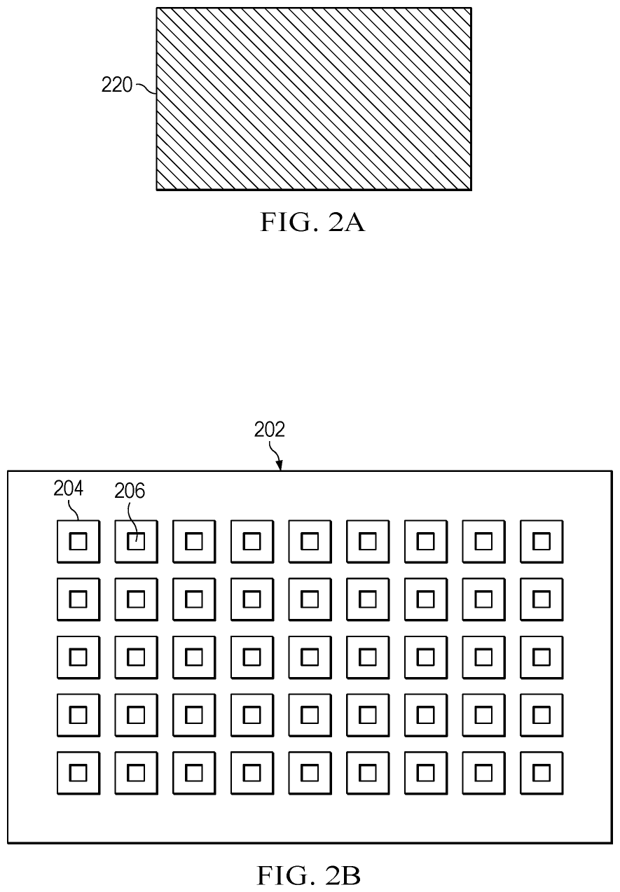

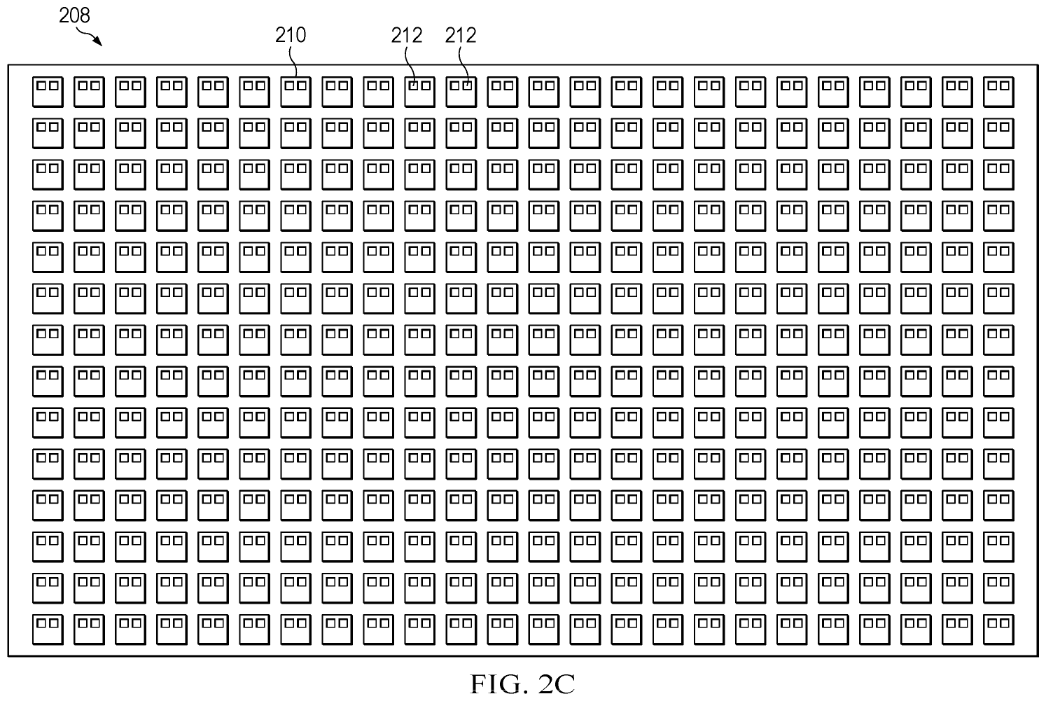

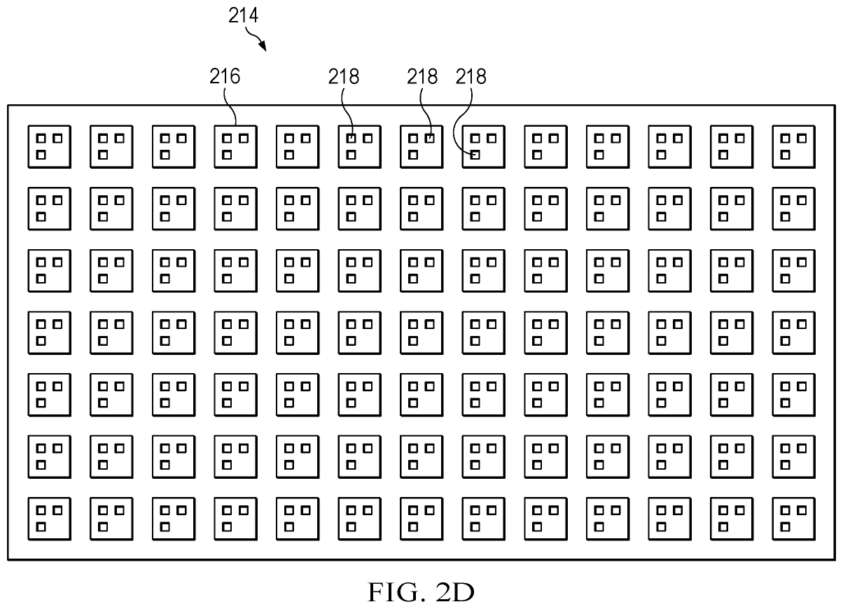

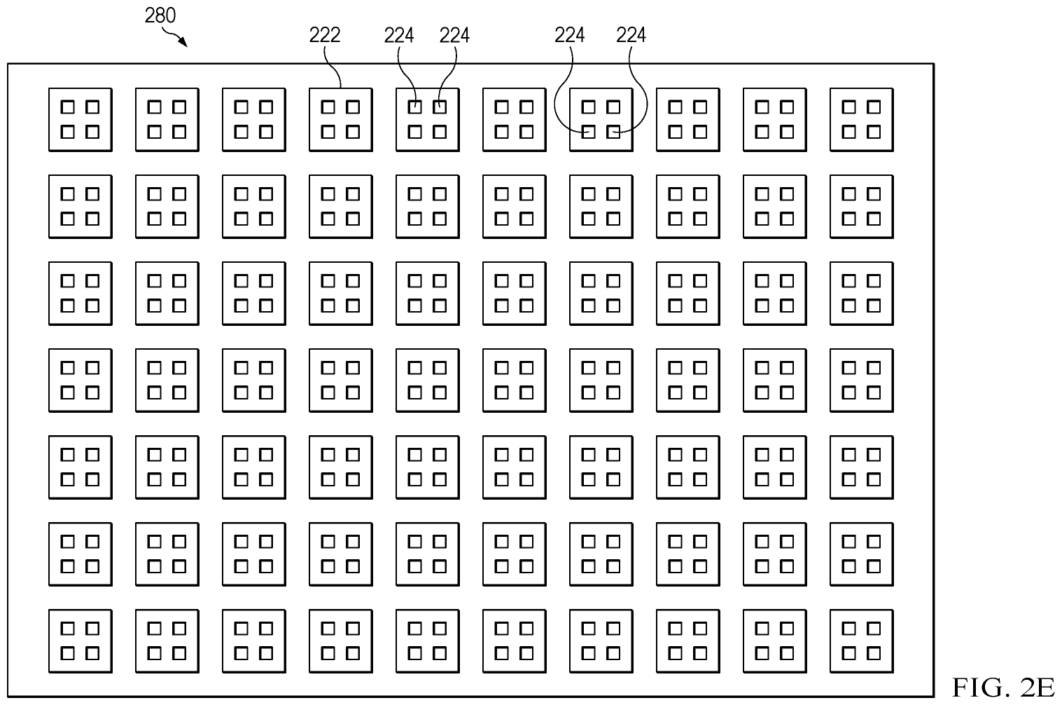

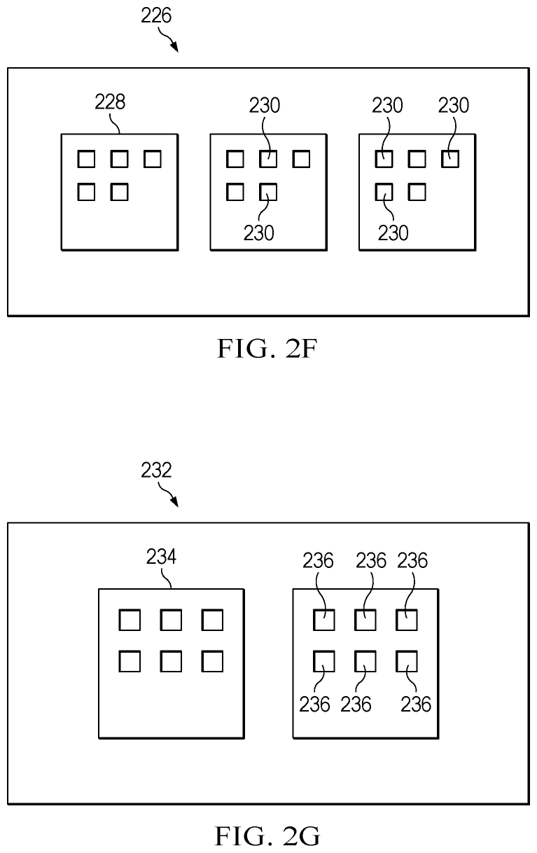

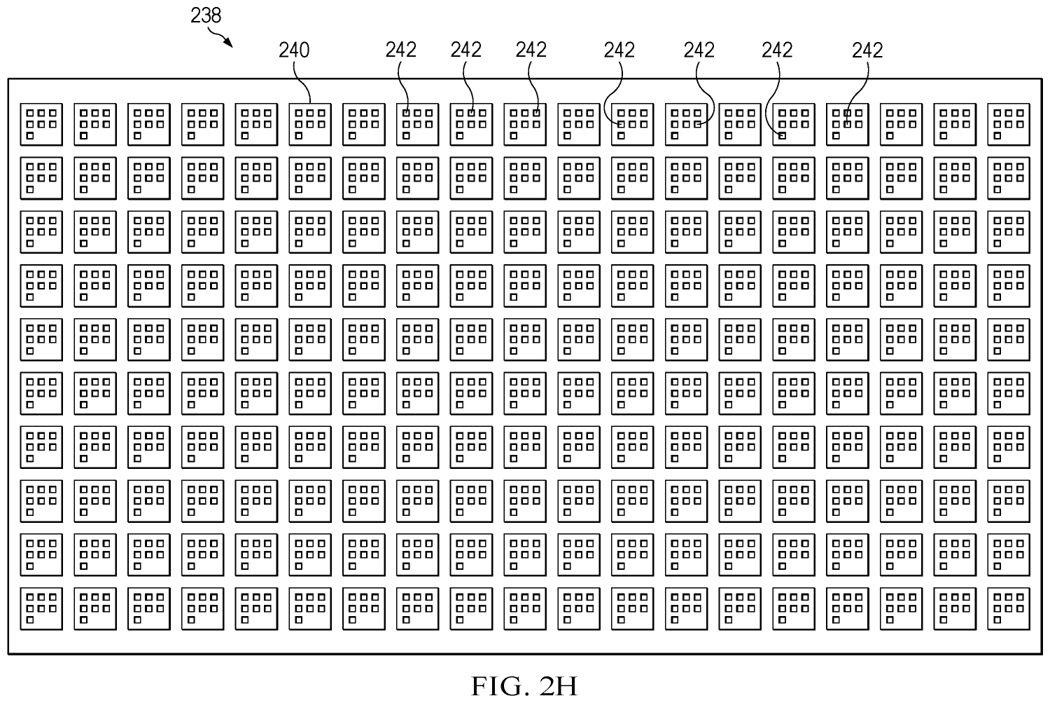

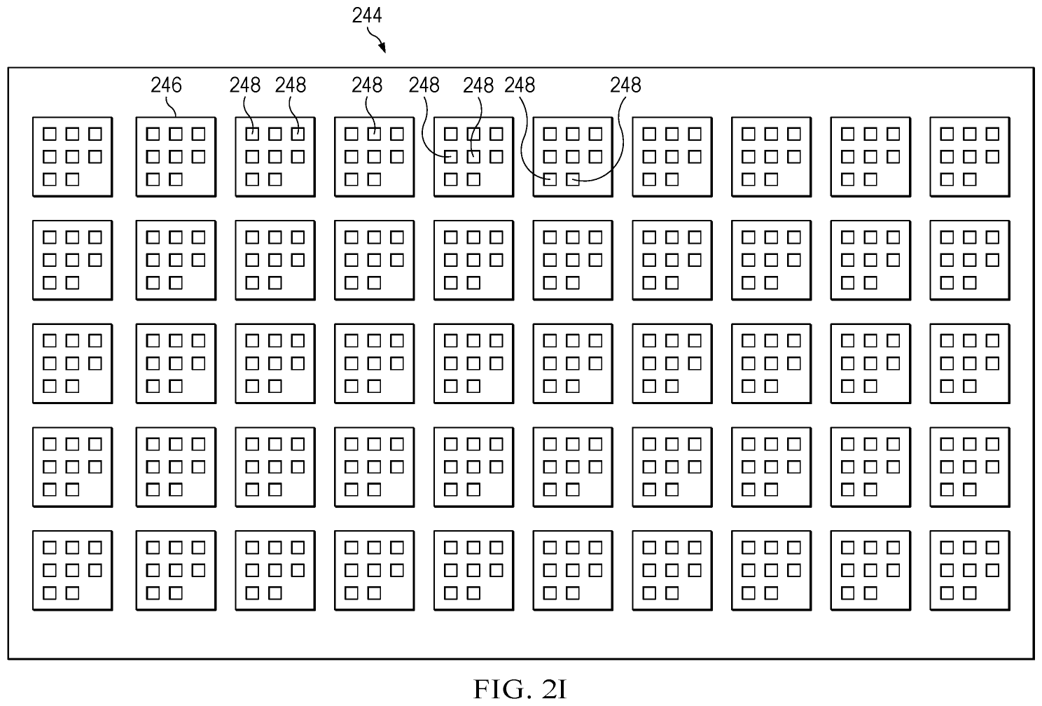

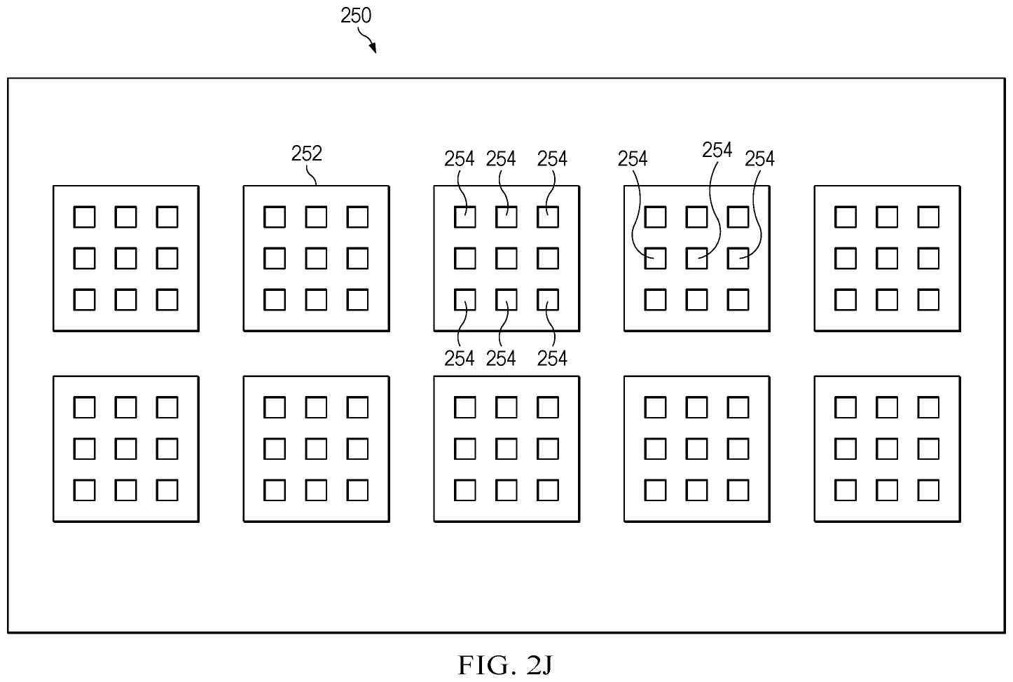

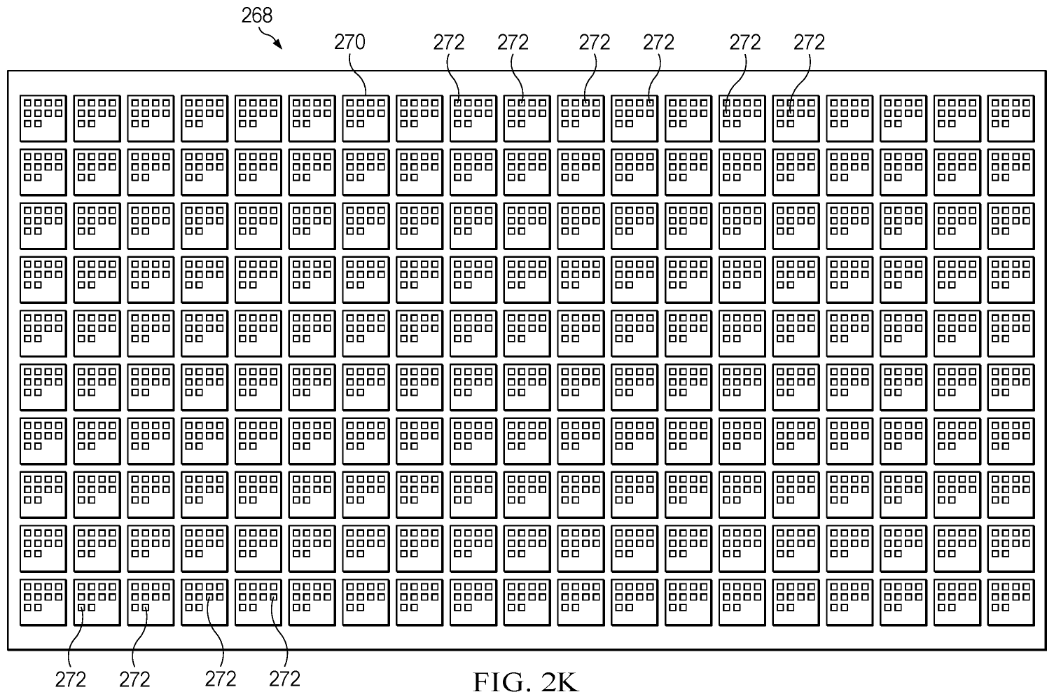

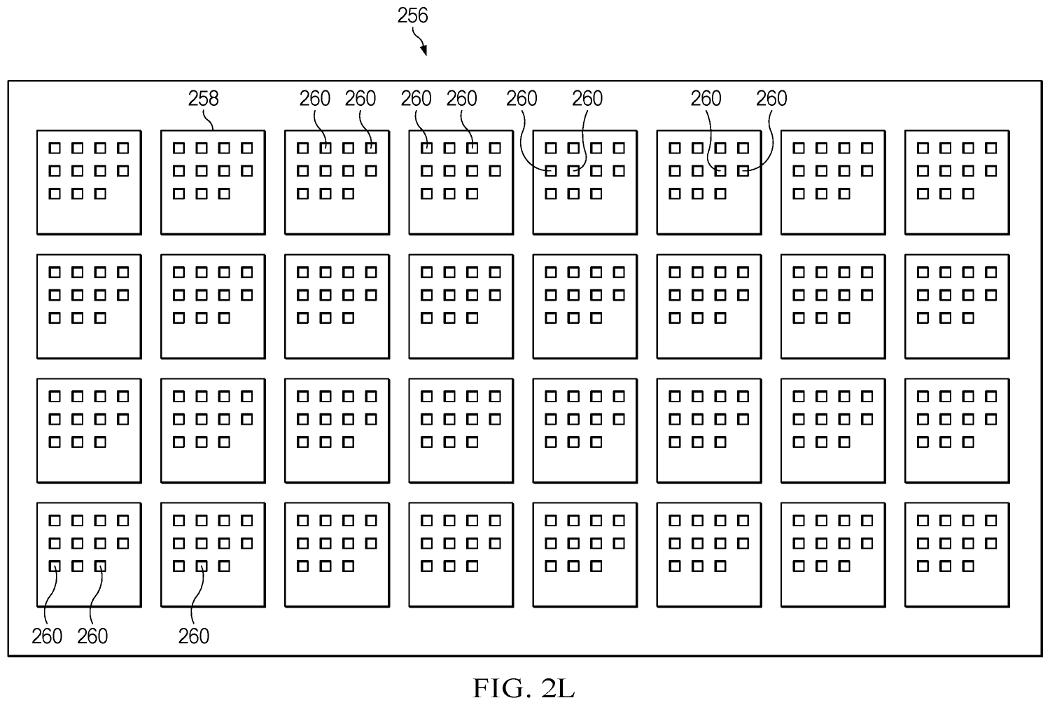

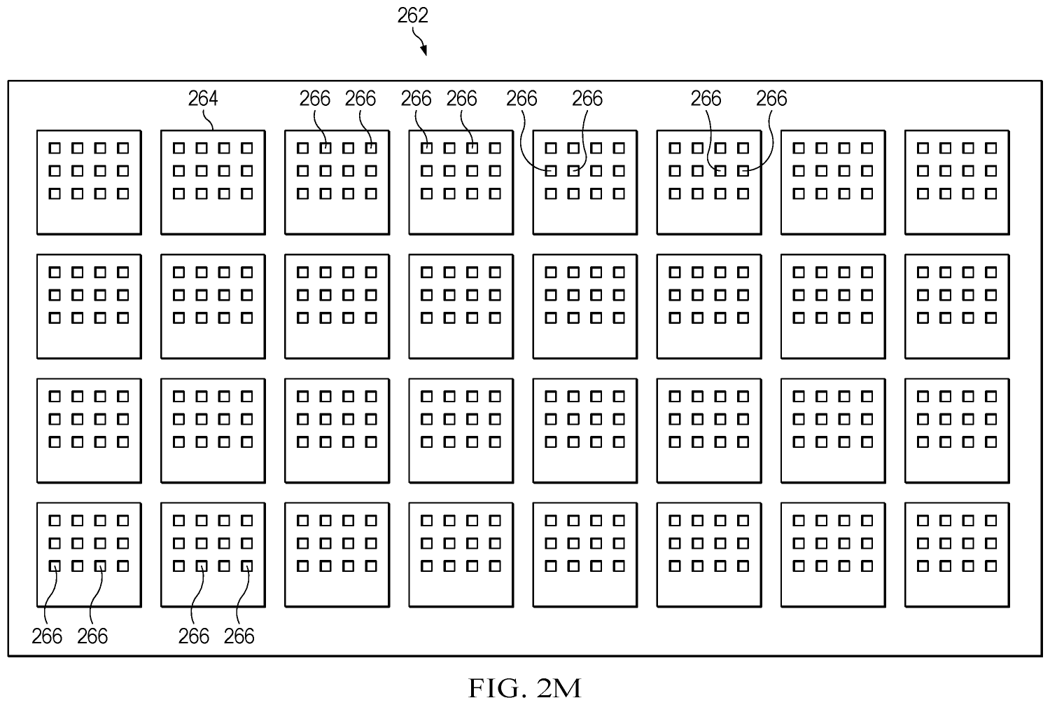

In an example, the opening pattern and the closing pattern are both solid color fields, for example the pattern 220 illustrated in FIG. 2A. In an example, the opening pattern and the closing pattern are both black fields. In other examples, the opening pattern is different than the closing pattern. In other examples, the opening pattern and the closing pattern are different colored fields, for example white, red, orange, yellow, green, blue, or purple fields. In an example, as illustrated by FIGS. 2B-2M, the command pattern contains blobs containing holes. Projection of the command pattern containing blobs containing holes is invariant to projection surface geometry and other types of distortion. In an example, the number of holes per blob indicate a command and the number of blobs provides recumbency.

FIG. 2B illustrates command pattern 202 containing blobs 204 containing holes 206. The command pattern 202 contains 45 blobs 204 and one hole 206 per blob. FIG. 2C illustrates the command pattern 208 containing blobs 210 containing holes 212. The command pattern 208 contains 336 blobs 210 and two holes 212 per blob. FIG. 2D illustrates command pattern 214 containing blobs 216 containing holes 218. The command pattern 214 contains 91 blobs 216 and three holes 218 per blob. FIG. 2E illustrates command pattern 280 containing blobs 222 and holes 224. The command pattern 280 contains 60 blobs 222 and four holes 224 per blob. FIG. 2F illustrates command pattern 226 containing blobs 228 containing holes 230. The command pattern 226 contains three blobs 228 and five holes 230 per blob. FIG. 2G illustrates command pattern 232 containing blobs 234 containing holes 236. The command pattern 232 contains two blobs 234 and six holes 236 per blob. FIG. 2H illustrates command pattern 238 containing blobs 240 containing holes 242. The command pattern 238 contains 190 blobs 240 and seven holes 242 per blob. FIG. 2I illustrates command pattern 244 containing blobs 246 containing holes 248. The command pattern 244 contains 50 blobs 246 and eight holes 248 per blob. FIG. 2J illustrates command pattern 250 containing blobs 252 containing holes 254. The command pattern 250 contains ten blobs 252 and nine holes 254 per blob. FIG. 2K illustrates command pattern 268 containing blobs 270 containing holes 272. The command pattern 268 contains 190 blobs 270 and ten holes 272 per blob. FIG. 2L illustrates command pattern 256 containing blobs 258 containing holes 260. The command pattern 256 contains 32 blobs 258 and 11 holes 260 per blob. FIG. 2M illustrates command pattern 262 containing blobs 264 containing holes 266. The command pattern 262 contains 32 blobs 264 and 12 holes 266 per blob.

In the illustrated examples, the blobs and holes are square. However, in other examples, the blobs and holes may be different shapes, for example circles, rectangles, ovals, triangles, or an irregular shape. In the illustrated examples, the blobs and holes have the same shape. However, in other examples, the holes may be shaped differently than the blobs. In the illustrated examples, the holes are disposed in a grid pattern. However, in other examples, the holes may have a different pattern. For example, the holes may be placed symmetrically within the blobs. In an example, each command pattern contains the same number of blobs. In other examples, different command patterns contain different numbers of blobs. For example, there may be fewer blobs in commands with more holes per blob. In some examples (not illustrated), a blob with no holes indicates a command. In different examples, there may be a different number of commands. The number of commands may depend on the field of view (FOV) of the projectors and the FOV of the cameras. In FIGS. 2B-2M, the multiple instances of the blobs with hole adds redundancy to reduce errors. In an example, the blobs 204 are white and the holes 206 are black. In other examples, the blobs are a different color, for example red, orange, yellow, green, blue, purple, or black. In other examples, the holes are a different color, for example red, orange, yellow, green, blue, purple, or white.

The camera-projector system 112 contains a processor 118 coupled to a projector 114, to a memory 120, and to a camera 116. The processor 118, the projector 114, the memory 130 and the camera 116 are mechanically coupled to each other. The camera 116 captures an image of the image projected by the projector 104. The processor 118 decodes the captured image and stores the captured image in the memory 120. Based on the decoding of the captured image, the processor 118 instructs the projector 114 to project a response image. The response image or an indication of the response image, for example a color and an indication that the pattern is a solid field, may be retrieved by the processor 118 from the memory 120. The camera 106 captures an image of the response image, and the processor 108 proceeds based on the captured response image. In an example, the camera 106 captures images of a command sequence, for example an opening pattern, a command pattern after the opening pattern, and a closing pattern after the opening pattern. In an example, the opening pattern and the closing pattern are solid color fields, for example black fields. In an example, the command pattern is command pattern 202 illustrated in FIGS. 2B-2M. In an example, the processor 118 determines a number of blobs with holes in the command pattern and performs error checking on the command pattern. The response image may be a solid fields as illustrated in FIG. 2A.

In an example, the processor 118 instructs the projector 114 to projected a pass pattern in response to detecting an opening pattern followed by a command pattern and a closing pattern following the command pattern, and by detecting the number of blobs with holes in the command pattern including successfully error checking the command pattern. In an example, the pass pattern is a green field, although in other examples it may be another color, for example red, orange, yellow, blue, purple, black, or white fields. The processor 118 may retrieve the pass pattern or an indication of the pass pattern, for example a color and an indication that the pattern is a solid field, from the memory 120. In an example, the processor 118 instructs the projector 114 to project a fail pattern in response to failing to detect a sequence of three patterns, capturing an unknown pattern, or failing an error check. In an example, the fail pattern is a solid field, such as the pattern 220 illustrated in FIG. 2A. The processor 118 may retrieve the fail pattern or an indication of the fail pattern, for example a color and an indication that the pattern is a solid field, from the memory 120. In an example, the fail pattern is solid red. In other examples, the fail pattern is another color, for example orange, yellow, green, blue, purple, white, or black fields. Solid color fields being used for the fail pattern and the pass pattern are invariant to projection surface geometry and other types of distortion. In an example, green is used for the pass pattern and red is used for the fail pattern because they have the largest chromatic distance and are easily differentiated. In another example, red is used for the pass pattern and green is used for the fail pattern. In additional examples, different colors are used for the pass and fail patterns that have a large chromatic distance. In other examples, colors with a smaller chromatic distance are used. The camera 106 captures an image of the response pattern, and the processor 108 proceeds based the response pattern. For example, the processor 108 may continue to operate normally in response to identifying a pass pattern and may stop the operation of the camera-projector system 102 and produce an error message in response to identifying a fail pattern.

Similarly, the camera-projector system 122 contains a processor 128 coupled to a projector 124, to memory 130, and to a camera 126. The processor 128, the projector 124, the memory 130, and the camera 126 are mechanically coupled to each other. The camera 126 captures an image of the image projected by the projector 104. The processor 128 decodes the captured image and stores the captured image in the memory 130. Based on the decoding of the captured image, the processor 128 instructs the projector 124 to project a response image. The camera 106 captures an image of the response image, and the processor 108 proceeds based on the captured response image. In an example, the camera 126 captures images of a sequence of patterns, for example an opening pattern, a command pattern after the opening pattern, and a closing pattern after the opening pattern. In an example, the opening pattern and the closing pattern are solid fields, for example solid black fields. In an example, the command pattern is command pattern 202 illustrated in FIGS. 2B-2M. In an example, the processor 128 determines a number of blobs with holes in the command pattern and performs error checking on the command pattern. The response image may be a solid fields as illustrated in FIG. 2A.

In an example, the processor 128 instructs the projector 124 to projected a pass pattern in response to detecting an opening pattern followed by a command pattern, and a closing pattern following the command pattern, and by detecting the number of blobs with holes and successfully error checking the command pattern. The processor 128 may retrieve the pass pattern or an indication of the pass pattern, for example the color and an indication that the pattern is a solid field, from the memory 130. In an example, the pass pattern is a green field, although in other examples it may be another color, for example red, orange, yellow, blue, purple, black, or white. In an example, the processor 128 instructs the projector 124 to project a fail pattern in response to failing to detect a sequence of three patterns, capturing an unknown pattern, or failing an error check. In an example, the fail pattern is a solid field, such as the pattern 220 illustrated in FIG. 2. The processor 128 may retrieve the fail pattern from the memory 130. In an example, the fail pattern is solid red. Solid color fields being used for the fail pattern and the pass pattern are invariant to projection surface geometry and other types of distortion. In other examples, the fail pattern is another color, for example orange, yellow, green, blue, purple, white, or black. In an example, green is used for the pass pattern and red is used for the fail pattern because they have the largest chromatic distance and are easily differentiated. In another example, red is used for the pass pattern and green is used for the fail pattern. In additional examples, different colors are used for the pass and fail patterns that have a large chromatic distance. In other examples, colors with a smaller chromatic distance are used. The camera 106 captures an image of the response pattern, and the processor 108 proceeds based the response pattern. For example, the processor 108 may continue to operate normally in response to identifying a pass pattern and may stop the operation of the camera-projector system 102 and produce an error message in response to identifying a fail pattern.

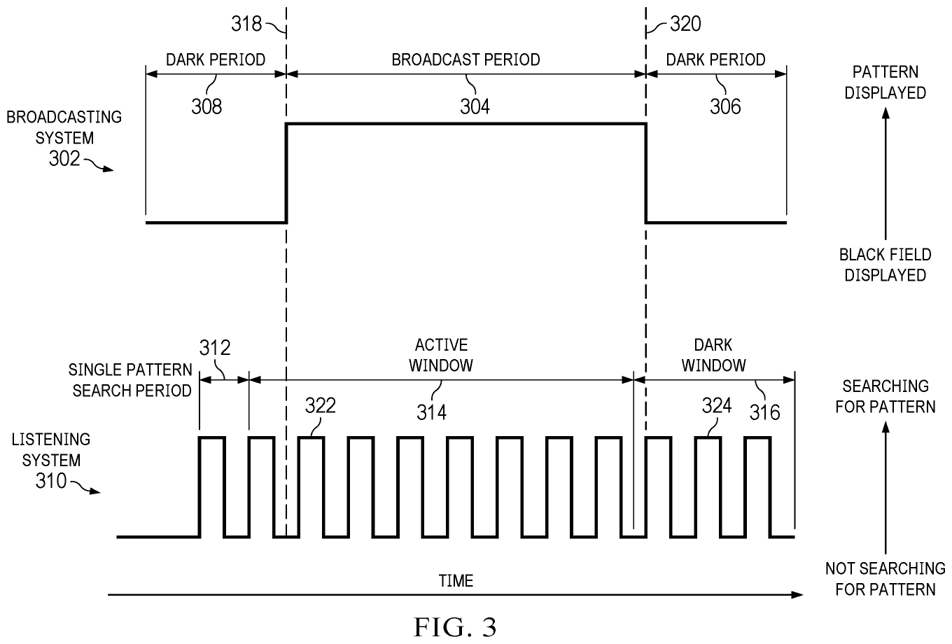

FIG. 3 illustrates example pattern broadcast and listening sequences. FIG. 3A illustrates a broadcast pattern 302 and a listening sequence 310. The broadcast pattern 302 is projected by a broadcast system, for example by the camera-projector system 102 illustrated in FIG. 1, and the listening sequence 310 is performed by a listening system, for example the camera-projector system 112 and the camera-projector system 122, illustrated in FIG. 1. The broadcasting system, illustrated by the broadcast pattern 302, projects a dark period 308, followed by a broadcast period 304, followed by a dark period 306. In an example, the dark period 308, the broadcast period 304, and the dark period 306 are on the order of milliseconds. At time 318, the camera-projector system 102 transitions from projecting an opening pattern, for example the dark period 308 during which the projector 104 displays a black field, to the broadcast period 304, for example during which the projector 104 displays a command pattern. At time 320, the camera-projector system 102 transitions from displaying the command pattern to displaying a closing pattern, for example the dark period 306. The projection of a command pattern between an opening pattern and a closing pattern enables coordination between the camera-projector system 102 and the camera-projector systems 112 and 122 without a global clock signal.

The listening system, for example the camera-projector system 112 and/or and the camera-projector system 122, periodically searches for a pattern with the sequence 310. Search cycle 312 illustrates a single pattern search period for the listening system. At a search cycle 322, the first full search cycle after the time 318, the listening system detects the transition from the dark period 308 to the broadcast period 304. Accordingly, during the active window 314, the listening system detect the transition from the dark period 308 to the broadcast period 304. Then, at a search cycle 324, the first full search cycle after the time 320, the listening system detect the transition from the broadcast period 304 to the dark period 306. Accordingly, during the dark window 316, the listening system detects the transition from the broadcast period 304 to the dark period 306. The listening system only detects a command sequence when it detects a transition from an opening pattern to a command pattern followed by a transition from the command pattern to the closing pattern, enabling coordination between the camera-projector systems without the use of a global clock signal.

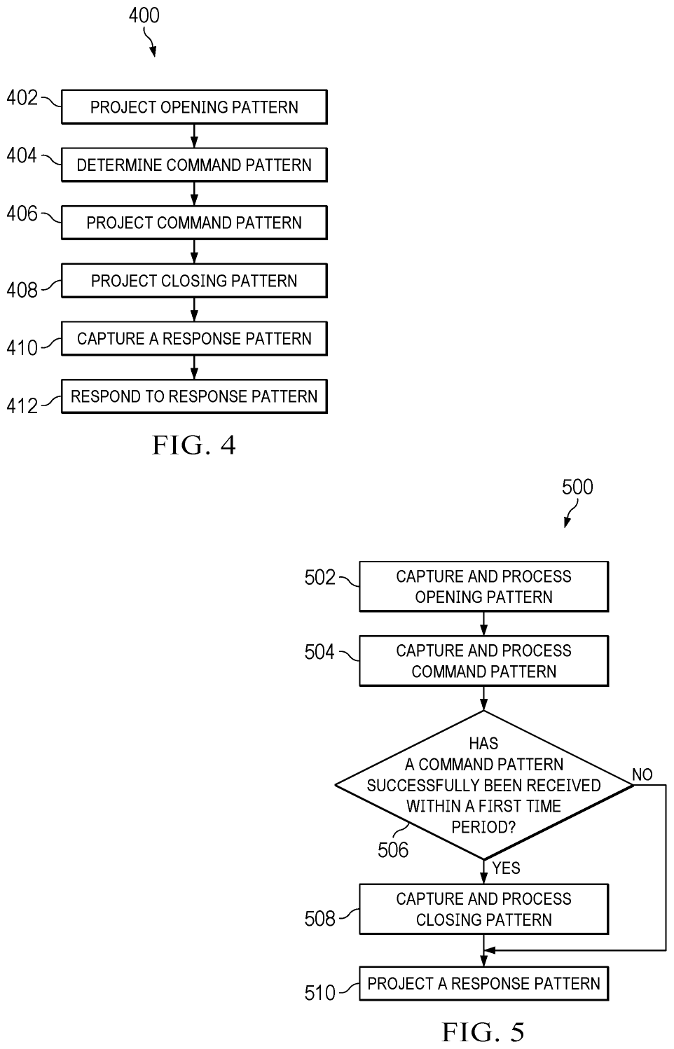

FIG. 4 illustrates a flowchart of an example method 400 of projector camera communication. The method 400 is performed by a camera-projector system, for example by the camera-projector system 102 illustrated in FIG. 1. In the block 402, the projector 104 of the camera-projector system 102 projects an opening pattern on the projection surface 140. The projector 104 may retrieve the opening pattern or an indication of the opening pattern, for example the color and an indication that the opening pattern is a color field, from the memory 110. In an example, the opening pattern is a black field. The use of a black field for the opening pattern is useful because it is easy to detect, saves power, and may be used to correct for ambient noise when detecting the command pattern. In other examples, the opening pattern is another color field, or another pattern.

In the block 404, the processor 108 of the camera-projector system 102 determines a command pattern. The command pattern may be a pattern of blobs with holes, where the number of holes in each blob indicates the pattern, and the multiple blobs provide redundancy. In an example, the processor 108 retrieves the command pattern or an indication of the command pattern, for example the number of holes per blob, the number of blobs, and the color of the blobs, from the memory 110. In an example the blobs are white blobs in a black field with black holes. The use of white blobs on a black field with black holes maximizes the contrast between the blobs and the holes and between the blobs and the background. In an example, the use of blobs with holes enables the use of an irregular projection surface 140. In other examples, the blobs are a different color, for example red, orange, yellow, green, blue, or purple.

In the block 406, the projector 104 of the camera-projector system 102, after projecting the opening pattern in the block 402, projects the command pattern determined by the processor 108 in the block 404 on the projection surface 140.

In the block 408, the projector 104 of the camera-projector system 102 projects the closing pattern on the projection surface 140 after projecting the command pattern in the block 406. In an example, the closing pattern is a black field. The projector 104 may retrieve the closing pattern, or an indication of the closing pattern, for example the color and an indication that the closing pattern is a color field, from the memory 110. In an example, the closing pattern is the same as the opening pattern. In another example, the closing pattern is the different from the opening pattern, for example a different color field or another different pattern. In an example, the closing pattern is a black field. The use of a black field as the closing patterns saves power and maximizes contrast between the command pattern and the closing pattern.

In the block 410, the camera 106 of the camera-projector system 102 captures a response pattern, which is in response to projecting the command sequence of the opening pattern, followed by the command pattern, followed by the closing pattern. The processor 108 may store the response pattern in the memory 110. In an example, the response pattern is either a pass pattern or a fail pattern. The pass pattern indicates successful communication of the opening pattern, followed by the command pattern, followed by the closing pattern. A fail pattern indicates unsuccessful communication of the opening pattern, the command pattern and/or the closing pattern. The fail pattern may also indicate another type of error in the listening system. In an example, the pass pattern is a green field and the fail pattern is a red field. In other examples, different solid fields or different patterns are used for the pass pattern and the fail pattern.

In the block 412, the camera-projector system 102 responds to the response pattern. For example, in response to capturing a pass pattern, the processor 108 instructs the projector 104 and the camera 106 to operate normally. In an example, in response to receiving a fail pattern, the processor 108 may instruct the projector 104 to retransmit the sequence of the opening pattern, the command pattern, and the closing pattern. In an example, the camera-projector system 102 instructs the projector 104 to project a fail pattern, for example a red field, in response to receiving a fail pattern, to instruct the other camera-projector systems of the error, and to stop normal operation. The processor 108 may instruct the projector 104 to project a fail pattern in response to a processing error. The processor 108 may retrieve the response pattern or an indication of the response pattern, for example a color and an indication that the response pattern is a color field, from the memory 110. Additionally or alternatively, the processor 108 may produce an error message and/or cease normal operation of the camera-projector system 102.

FIG. 5 illustrates a flowchart 500 of the example method of projector camera communication. In the block 502, the camera 116 of the camera-projector system 112 and/or the camera 126 of the camera-projector system 122 (“the listening camera”) captures an image of an opening pattern and the processor 118 of the camera-projector system 112 and/or the processor 128 of the camera-projector system 122 (“the listening processor”) processes the opening frame. The camera 116 and/or the camera 126 stores the opening frame in the memory 120 and/or the memory 130 (“the listening memory”), respectively. The opening pattern may be a color field, for example a black field. In other examples the opening pattern is another color field, or another pattern. The listening processor determines whether an opening frame has been received. When the processor 118 and/or the processor 128 determines that an opening frame has been received, the camera-projector system 112 and/or the camera-projector system 122 (“the listening projector”) proceeds to the block 504.

In the block 504, the listening camera captures a command pattern and the listening processor processes the command pattern. The listening camera may store the command pattern in the listening memory. The command pattern may be a pattern of blobs with holes, in which the number of holes per blob indicates a command and the multiple blobs provides redundancy for error checking. In an example, the blobs are white with black holes.

In the block 506, the listening processor determines whether it has successfully received a command pattern within a first time period. When the listening processor successfully receives the command pattern within the first time period, the listening camera-projector system proceeds to the block 508. When the listening processor does not successfully receive the command pattern within the first time period, the listening camera-projector system proceeds to the block 510 for the listening projector to project a fail pattern for the response pattern. The listening processor does not successfully detect a command pattern within the first time period when a command pattern is not received within the first time period or when a received command pattern fails an error check.

In the block 508, the listening camera receives a closing pattern and the listening processor processes the closing pattern. The listening camera may store the closing pattern in the listening memory. The closing pattern may be a solid field, for example a black field. When the listening processor receives a closing pattern within a second time period of receiving the command pattern, the command sequence has been successfully received, and the listening processor produces a pass pattern for the response pattern. When the listening processor does not receive the closing pattern within the second time period, the listening processor produces a fail pattern for the response pattern.

In the block 510, the listening projector projects a response pattern. The listening processor may retrieve the response pattern, or an indication of the response pattern, for example a color and an indication that the response pattern is a color field, the listening memory. The response pattern may be a fail pattern or a pass pattern. The listening projector may project a fail pattern in response to a processing error, even when the listening camera-projector system successfully received a sequence of an opening pattern, a command pattern, and a closing pattern. In an example, the fail pattern and the pass pattern are solid fields having different colors, for example a red field for the fail pattern and a green field for the pass pattern. In other examples, the pass pattern and the fail pattern are different color fields or different patterns.

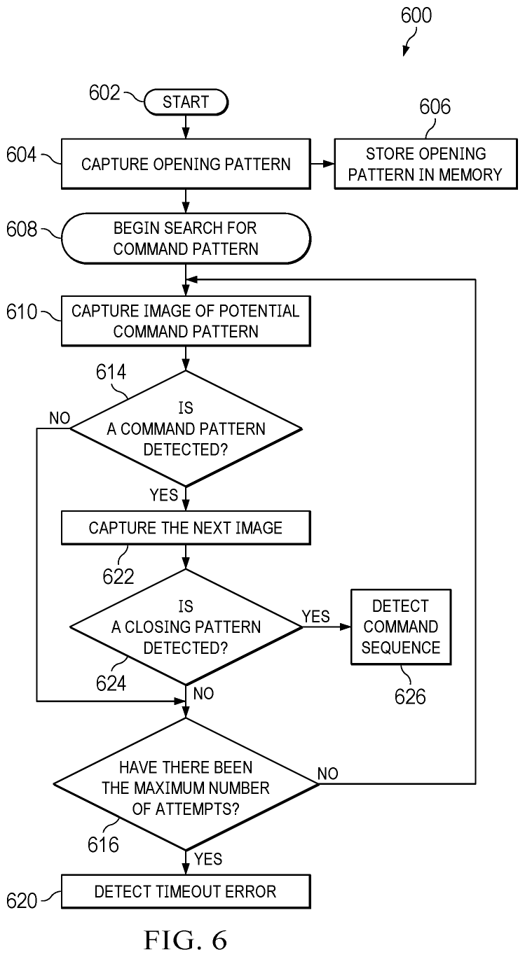

FIG. 6 illustrates a flowchart 600 of an example method of pattern cycle detection which may be performed by a listening camera-projector system, the camera-projector system 112 and/or the camera-projector system 122 of FIG. 1. In an example, the flowchart 600 is an example of the blocks 502, 504, 506, 508, and 510 of FIG. 5. In a block 602, the method starts. In a block 604, the listening camera captures an opening pattern. The block 604 may be an example of the block 502 in FIG. 5. In an example, the opening pattern is a solid field, for example a black field, and the listening processor will determine that the opening pattern is detected when an active pattern is not detected. In other examples, the opening pattern is a different solid field or another pattern. In a block 606, the listening processor stores the opening pattern in the listening memory.

In a block 608, the listening camera-projector system begins searching for a command pattern. The listening processor initializes the number of attempts to zero and stores the number of attempts in the listening memory. In a block 610, the listening camera captures an image of a potential command pattern. The listening processor may store the captured potential command pattern in the listening memory. The listening processor increments the number of attempts and stores the number of attempts in the listening memory. The block 610 may be an example of the block 504 illustrated in FIG. 5. In the block 610, the listening processor retrieves the opening pattern from the listening memory, and subtracts the retrieved opening pattern from the potential command pattern to produce a subtracted pattern. Subtracting the retrieved opening pattern from the potential command pattern removes ambient noise from the potential command pattern.

In a block 614, the listening processor determines whether the subtracted pattern is a command pattern. The block 614 may be an example of the block 506 illustrated in FIG. 5. Initially, the listening processor may determine whether the dominant color of the subtracted pattern is the expected color for a command pattern, for example white. When the listening processor determines that the dominant color is not the expected color, the listening camera-projector system proceeds to the block 616. When the listening processor determines that the dominant color of the subtracted pattern is the expected color, the listening processor detects blobs with holes in the subtracted pattern. When the listening processor does not detect blobs with holes in the subtracted pattern, the listening camera-projector system proceeds to the block 616. When the listening processor detects blobs with holes, the listening processor counts the number of holes per blob in the subtracted image. The listening processor determines the confidence level for the detected blobs with holes on the subtracted image. When the confidence level is below a threshold, the listening camera-projector system proceeds to the block 616. When the confidence level is greater than or equal to the threshold, the listening camera-projector system proceeds to a block 622.

In the block 622, the listening camera captures the next image. In the block 624, the listening processor determines whether the next captured image is the closing pattern. In an example, the block 622 and the block 622 are examples of the block 508 illustrated in FIG. 5. The listening processor may retrieve the opening pattern from the listening memory and subtract the opening pattern from the next captured image to remove ambient light. The listening processor determines whether the next captured image is the closing image. For example, when the closing image is expected to be a black field, the processor 118 and/or the processor 128 will determine that the next captured image is the closing image when an active pattern is not detected. When the listening processor determines that the closing pattern is detected, the listening camera-projector system proceeds to the block 626. When the processor 118 and/or the processor 128 determines that a closing pattern is not detected, the camera-projector system 112 and/or the camera-projector system 122 proceeds to the block 616.

In the block 626, the listening camera-projector system detects a command sequence. The listening processor controls the listening camera-projector system based on the command detected in the command sequence. For example, the listening processor may query the listening memory to determine an operation to perform based on the number of holes detected per blob. The listening camera-projector system perform the determined operation. Additionally, the listening projector projects a pass image, for example a green field.

In the block 616, the listening processor determines whether there have been the maximum number of attempts to detect a command pattern. The listening processor retrieves the number of attempts and the maximum number of attempts from the listening memory. When the number of attempts is less than the maximum number of attempts, the listening camera-projector system proceeds to the block 610 to capture another image of a potential command pattern. When the number of attempts is greater than or equal to the maximum number of attempts, the listening camera-projector system proceeds to a block 620 to detect a timeout error.

In the block 620, the listening camera-projector system detects a timeout error. The listening camera-projector system may stop normal operation and display an error message for a user. The listening projector may also project a fail pattern, for example a red field.

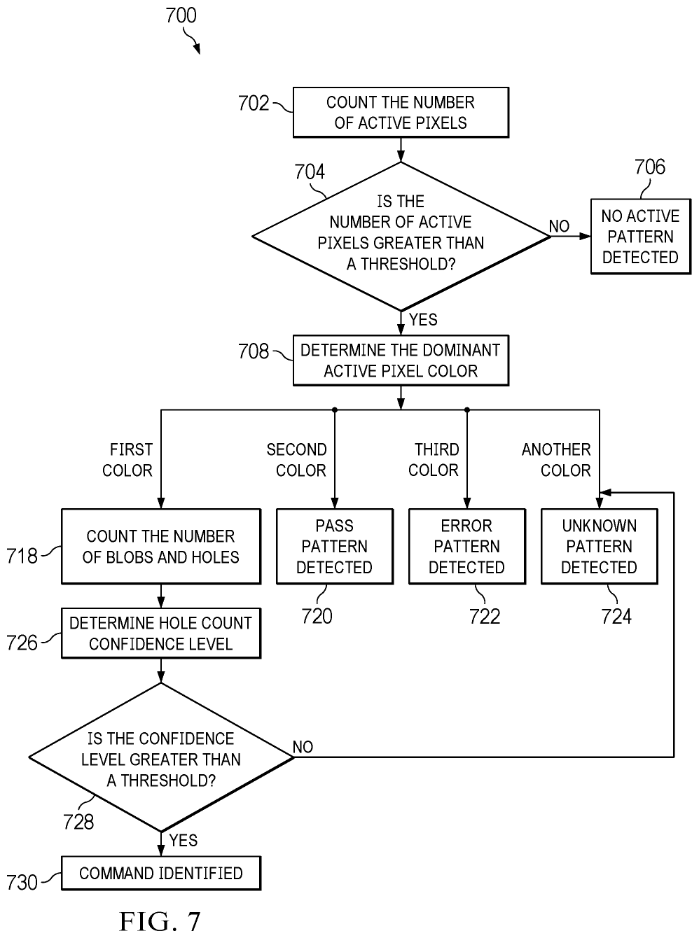

FIG. 7 illustrates a flowchart 700 of an example method of projection pattern detection. The method may be performed by the processor 108 and the memory 110 of the camera-projector system 102, the processor 118 and the memory 120 of the camera-projector system 112, or the processor 128 and the memory 130 of the camera-projector system 122. The method may be an example of the block 410 illustrated in FIG. 4, the block 502 illustrated in FIG. 5, the block 504 illustrated in FIG. 5, the block 508 illustrated in FIG. 5, the block 604 illustrated in FIG. 6, the block 614 illustrated in FIG. 6, or the block 624 illustrated in FIG. 6.

In a block 702, the processor counts the number of active pixels in a received image. In a block 704, the processor determines whether the number of active pixels is greater than a threshold. The processor may retrieve the threshold from the memory and compare the number of active pixels to the threshold. When the number of active pixels is greater than the threshold, the camera-projector system proceeds to a block 708. When the number of active pixels is less than or equal to the threshold, the camera-projector system proceeds to a block 706. In the block 706, the processor determines that no active pattern is detected. For example, the processor may determine that a black field was projected, which does not have a large number of active pixels.

In the block 708, the processor determines the dominant active pixel color. In an example, the processor only considers the active pixels, which increases the execution speed. When the dominant active pixel color is a first color, for example white, the processor proceeds to the block 718. When the dominant active pixel color is a second color, for example green, the processor proceeds to a block 720. When the dominant active color is a third color, for example red, the processor proceeds to the block 722. When the dominant color is another color besides the first color, the second color, and the third color, the processor proceeds to a block 724. In the block 724, the processor determines that an unknown pattern is detected. In the block 722, the processor detects a fail pattern. In the block 720, the processor detects a pass pattern.

In the block 718, the processor counts the number of blobs and the number of holes in each blob. In an example, only active pixels are analyzed to detect blobs, which increases the execution speed. The processor performs a connected component analysis (CCA) to detect the number of individual blobs and to determine the number holes per blob. The CCA detects blobs and their enclosed holes in a single pass to the image.

In a block 726, the processor determines a hole count confidence level based on the number of blobs and the number of holes per blob detected in the block 718. A symbol including a blob with holes is repeated throughout the command pattern to increase detection robustness in challenging lighting conditions. In an example, the confidence level (CL) is given by:

$$C L = 1 \; 00 \% ( \frac{{M}_{x}}{N} ) ,$$

where Mₓ is the statistical mode of the number of holes per symbol and N is the number of detected blobs.

In a block 728, the processor determines whether the confidence level is greater than a threshold. The processor may read the threshold from the memory. In an example, the threshold is 50%. In other examples, the threshold may be another value, for example between 35% and 70%. When the processor determines that the confidence level is less than or equal to the threshold, the camera-projector system proceeds to the block 724 and an unknown pattern is detected. When the processor determines that the confidence level is greater than the threshold, the camera-projector system proceeds to a block 730, and a command is identified.

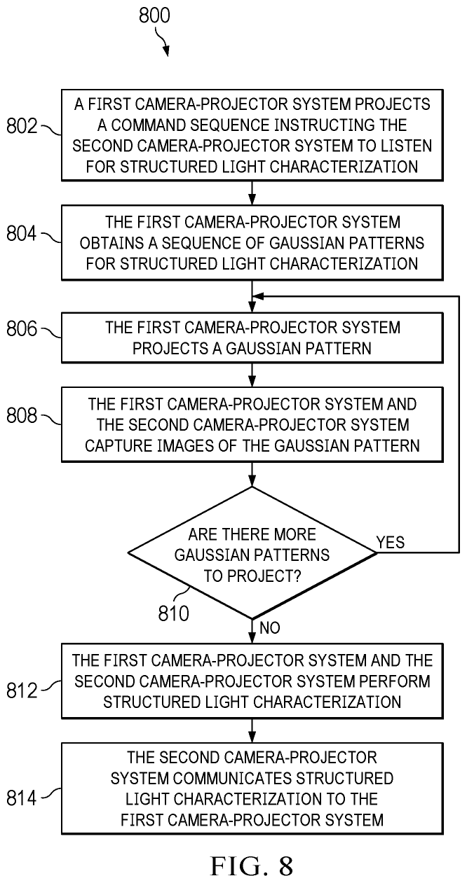

FIG. 8 illustrates a flowchart 800 for an example method of structured light characterization. In an example, sparse projection surface geometric characterization is used while communicating between camera-projector systems, for example between the camera-projector system 102 and the camera-projector system 112 and/or the camera-projector system 122. Sparse projection surface characterization is a structured light based surface geometric characterization. Time multiplexed two dimensional (2D) gaussian patterns are projected by a projector, for example by the projector 104 of camera-projector system 102 in FIG. 1. The time multiplexed 2D gaussian patterns may be Gray-encoded. In a block 802, a first camera-projector system, for example the camera-projector system 102, projects a command sequence instructing a second camera-projector system, for example the camera-projector system 112 and/or the camera-projector system 122, to listen for structured light characterization from the first camera-projector system. A first projector of the first camera-projector system projects an opening pattern, followed by a command pattern indicating a command instructing other camera-projector systems to perform structured light characterization, followed by a closing pattern. A second camera of the second camera-projector system captures the opening pattern, followed by the command pattern, and followed by the closing pattern. A second processor of the second camera-projector system decodes the command pattern, including determining a confidence level for the command detection.

In a block 804, a first processor of the first camera-projector system obtains a sequence of gaussian patterns for structured light characterization. The first processor may read the sequence of gaussian patterns from a first memory of the first camera-projector system. The sequence of gaussian patterns, which will be time multiplexed 2D gaussian patterns, may be Gray-encoded.

In a block 806, the first camera-projector system projects a gaussian pattern. The first projector projects the gaussian patterns from the sequence of gaussian patterns obtained in the block 806 in a time sequence. The first camera-projector system projects a pattern cycle with an opening pattern, followed by a command pattern containing a gaussian pattern, and followed by a closing pattern. In a block 808, a first camera of the first camera-projector system captures a first image of the projected gaussian pattern and a second camera of the second camera-projector system captures a second image of the projected gaussian pattern. The second camera-projector system captures the second image between capturing an opening pattern and a closing pattern. The first camera-projector system stores the first captured image in a first memory and the second camera-projector system stores the second captured image in a second memory. In a block 810, the first processor of the first camera-projector system determines whether there are more gaussian patterns to project in the time sequence of gaussian patterns. When there are more gaussian patterns to project in the sequence of gaussian patterns, the first camera-projector system returns to the block 806 to project the next gaussian pattern. When there are not more gaussian patterns to project, the first camera-projector system proceeds to a block 812.

In a block 812, the first camera-projector system and the second camera-projector system perform structured light characterization on the displayed gaussian data. The first processor of the first camera-projector system produces a first structured light characterization based on the sequence of first captured images to produce a first point cloud. The second processor of the second camera-projector system produces a first structured light characterization based on the sequence of second captured images to produce a second point cloud.

In the block 814, the second projector of the second camera-projector system projects the second point cloud. The second camera-projector system projects an opening pattern before projecting the second point cloud and projects a closing pattern after projecting the second point cloud. The first camera-projector system captures the second point cloud. Then, the first processor of the first camera-projector system processes produces a combined point cloud based on the first point cloud and the second point cloud. The first point cloud and the second point cloud will be different due to the different perspectives of the first camera and the second camera.

Moreover, the scope of the present application is not intended to be limited to the particular illustrative example arrangement of the process, machine, manufacture, and composition of matter means, methods and steps described in this specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding example arrangements described herein may be utilized according to the illustrative arrangements presented and alternative arrangements described, suggested or disclosed. Accordingly, the appended claims are intended to include within their scope such processes, machines, manufacture, compositions of matter, means, methods, or steps.

What is claimed is:

1. A system comprising:
at least one processor configured to determine a command pattern; and
a projector coupled to the at least one processor, the projector configured to:
project an opening pattern;
project the command pattern after projecting the opening pattern; and
project a closing pattern after projecting the command pattern.

2. The system of claim 1, wherein the command pattern comprises blobs with holes per blob.

3. The system of claim 1, further a camera coupled to the at least one processor, the camera configured to capture a response pattern after projecting the closing pattern.

4. The system of claim 1, wherein the command pattern comprises a gaussian pattern, and wherein the system further comprises a camera coupled to the at least one processor, the camera configured to capture an image of the projected gaussian pattern.

5. The system of claim 4, wherein the at least one processor is further configured to produce a first point cloud based on the gaussian pattern and the camera is further configured to capture an image of a second point cloud.

6. A system comprising:
a camera configured to capture a first image;
at least one processor coupled to the camera, the at least one processor configured to:
in response to determining that the first image is an opening pattern, instruct the camera to capture a second image, wherein the camera is configured to capture the second image;
in response to determining that the second image is a command pattern:
instruct the camera to capture a third image, wherein the camera is configured to capture the third image; and
in response to determining that the third image is a closing pattern, detect a command sequence.

7. The system of claim 6, wherein determining that the second image is a command pattern comprises counting a number of blobs in the second image and a number of holes per blob in the second image.

8. The system of claim 6, wherein the command pattern comprises a red field or a green field, the opening pattern comprises a black field, and the closing pattern comprises a black field.

9. The system of claim 6, wherein the at least one processor is further configured to:
in response to determining that the second image is not a command pattern and determining that there have been a maximum number of attempts to detect the command pattern, detect a timeout error;
in response to determining that the third image is not a closing pattern and that there have been the maximum number of attempts to detect the command pattern, detect the timeout error; and
in response to detecting the timeout error, instructing a projector to project a fourth image indicating an error.

10. The system of claim 6, wherein determining that the second image is the command pattern comprises:
counting a number of blobs and a number of holes per blob in the second image;
determining a hole count confidence level for the number of blobs with holes in the second image; and
in response to determining that the hole count confidence level is greater than a threshold, identifying a command based on the number of blobs with holes and determining that the second image is the command pattern.

11. The system of claim 6, further comprising:
memory coupled to the at least one processor, the memory configured to store the first image; and
wherein determining that the second image is a command pattern comprises subtracting the first image from the second image.

12. The system of claim 6, wherein the command pattern comprises a gaussian pattern, the at least one processor further configured to produce a point cloud based on the gaussian pattern, the system further comprising:
a projector configured to project the point cloud.

13. A method comprising:
obtaining, by at least one processor, an image;
counting, by the at least one processor, a number of blobs in the image and a number of holes per blob;
determining, by the at least one processor, a hole count confidence level for the number of holes per blob the image; and
in response to determining that the hole count confidence level is greater than a threshold, identify a command based on the number of holes per blob.

14. The method of claim 13, wherein the image is a first image, the method further comprising:
capturing, by a camera, a second image;
in response to determining, by the at least one processor, that the second image is an opening pattern:
capturing, by the camera, the second image; and
in response to determining that the hole count confidence level is greater than the threshold, capturing, by the camera, a third image.

15. The method of claim 13, further comprising:
determining a dominant active pixel color of the image; and
detecting an unknown pattern in response to determining that the dominant active pixel color is a first color; and
wherein determining the hole count confidence level for the number of holes per blob in the image is performed in response to determining that the dominant active pixel color is a second color.

16. The method of claim 15, wherein the second color is white.

17. The method of claim 15, further comprising:
detecting a pass pattern in the image in response to determining that the dominant active pixel color is a third color; and
detecting a fail pattern in the image in response to determining that the dominant active pixel color is a fourth color.

18. The method of claim 13, wherein determining that the hole count confidence level is greater than a threshold is performed based on a statistical mode of a number of holes in the image and a number of blobs in the image.

19. The method of claim 13, wherein the image is a first image, the method further comprising in response to determining that the hole count confidence level is greater than a threshold, instruct a projector to project a pass pattern.

20. The method of claim 13, wherein the image is a first image, the method further comprising in response to determining that the hole count confidence level is less than or equal to the threshold, instruct a projector to project a fail pattern.
